(19) United States
(12) Patent Application Publication
(10) Pub. No.: US 2025/0233422 A1
(43) Pub. Date: Jul. 17, 2025

(54) IN-VEHICLE POWER SUPPLY DEVICE

(71) Applicant: TOYOTA JIDOSHA KABUSHIKI KAISHA, Toyota-shi (JP)

(72) Inventor: Daiki TAKAYAMA, Toyota-shi (JP)

(73) Assignee: TOYOTA JIDOSHA KABUSHIKI KAISHA, Toyota-shi (JP)

(21) Appl. No.: 19/006,841

(22) Filed: Dec. 31, 2024

(30) Foreign Application Priority Data
Jan. 16, 2024 (JP) 2024-004633

(51) Int. Cl. H02J 3/38; B60L 55/00; B60R 16/033; H01M 10/44; H01M 10/615; H01M 10/625; H01M 10/657; H02J 3/32; H02J 7/00; H02J 7/35

(52) U.S. Cl. CPC H02J 3/38; B60R 16/033; H01M 10/44; H01M 10/615; H01M 10/625; H01M 10/657; H02J 3/322; H02J 7/00712; H02J 7/35; B60L 55/00; H01M 2220/20; H02J 2300/24

(57) ABSTRACT

The in-vehicle power supply device includes a power storage device, an in-vehicle solar power generator mounted on the vehicle, a power regulator that performs charging of the power storage device using generated electric power from the in-vehicle solar power generator, charging of the power storage device using surplus electric power from an external solar power generator installed in an external facility, and supply of power from the power storage device to the external facility, and a control device that controls the power regulator. The control device controls the power regulator so as to start to warm the power storage device when the electric power generated by the in-vehicle solar power generator reaches first predetermined electric power or more and then to charge the power storage device using the surplus electric power from the external solar power generator.

### CROSS-REFERENCE TO RELATED APPLICATION

This application claims priority to Japanese Patent Application No. 2024-004633 filed on Jan. 16, 2024, incorporated herein by reference in its entirety.

### BACKGROUND

### 1. Technical Field

The present disclosure relates to in-vehicle power supply devices, and more particularly, to an in-vehicle power supply device that includes a power storage device and performs charging of the power storage device using surplus electric power from a solar power generator installed in an external facility and supply of electric power from the power storage device to the external facility.

### 2. Description of Related Art

Conventionally, as an in-vehicle power supply device of this type, there has been proposed a device that includes a solar power generator and a power storage device mounted on a vehicle, the device being configured to electrically connect the in-vehicle solar power generator and power storage device to a house including a solar power generator and a power storage device (see, for example, Japanese Unexamined Patent Application Publication No. 2014-236550 (JP 2014-236550 A)). The in-vehicle power supply device allows charging of the in-vehicle power storage device with generated electric power from the in-vehicle power supply device, charging of the in-vehicle power supply device with generated electric power from the solar power generator of the house, and supply of the electric power from the in-vehicle power supply device to the house.

### SUMMARY

However, in the in-vehicle power supply device, when the power storage device mounted on the vehicle is charged with the surplus electric power from the solar power generator of the house, the temperature of the power storage device needs to be a temperature suitable for charging. Therefore, when the vehicle side and the house side are electrically connected, the in-vehicle power supply device constantly warms the power storage device, resulting in increase in electric power loss.

A main object of an in-vehicle power supply device of the present disclosure is to reduce electric power loss in the charging of a power storage device using surplus electric power of an external solar power generator.

The in-vehicle power supply device of the present disclosure employs the following measure to achieve the main purpose.

An in-vehicle power supply device in a first aspect of the present disclosure includes:

a power storage device;
an in-vehicle solar power generator mounted on a vehicle;
a power regulator that performs charging of the power storage device using generated electric power from the in-vehicle solar power generator, charging of the power storage device using surplus electric power from an external solar power generator installed in an external facility, and supply of electric power from the power storage device to the external facility; and
a control device that controls the power regulator, in which
the control device controls the power regulator so as to start to warm the power storage device when the electric power generated by the in-vehicle solar power generator reaches first predetermined electric power or more and then to charge the power storage device using the surplus electric power from the external solar power generator.

The in-vehicle power supply device in a first aspect of the present disclosure includes:

an in-vehicle solar power generator mounted on a vehicle;
a power regulator that performs charging of the power storage device using generated electric power from the in-vehicle solar power generator, charging of the power storage device using surplus electric power from an external solar power generator installed in an external facility, and supply of electric power from the power storage device to the external facility; and
a control device that controls the power regulator.
The control device controls the power regulator so as to start to warm the power storage device when the electric power generated by the in-vehicle solar power generator reaches first predetermined electric power or more and then to charge the power storage device using the surplus electric power from the external solar power generator.
The first predetermined electric power is determined in advance as electric power that is slightly smaller than the electric power generated by the in-vehicle solar power generator that is used as an indication that the electric power generated by the external solar power generator becomes surplus in the external facility. In this way, the warming of the power storage device can be started shortly before the electric power generated by the external solar power generator becomes surplus in the external facility. Thereafter, when the power generated by the external solar power generator becomes surplus in the external facility, the power storage device can be charged using the surplus electric power from the external solar power generator. Therefore, the electric power loss can be reduced as compared with the case where the power storage device is constantly warmed. The external facility includes a general house.

In the in-vehicle power supply device of the first aspect of the present disclosure,

when a power storage ratio of the power storage device is equal to or more than a predetermined power storage ratio, the control device may not warm the power storage device even when the electric power generated by the in-vehicle solar power generator reaches second predetermined electric power or more. When the power storage ratio of the power storage device is equal to or more than the predetermined power storage ratio, charging of the power storage device using the surplus electric power may not be performed even when the generated electric power from the external solar power generator become surplus in the external facility, and therefore, the electric power loss in this case can be reduced.

An in-vehicle power supply device of a second aspect of the present disclosure includes:

a power storage device;
a power regulator that performs charging of the power storage device using surplus electric power from a solar power generator installed in an external facility, and supply of electric power from the power storage device to the external facility; and
a control device that controls the power regulator, in which
the control device controls the power regulator so as to start to warm the power storage device when the electric power generated by the solar power generator reaches second predetermined electric power or more and then to charge the power storage device using the surplus electric power from the solar power generator.

The in-vehicle power supply device of the second aspect of the present disclosure includes:

a power storage device;
the power regulator that performs charging of the power storage device using surplus electric power from the solar power generator installed in the external facility, and supply of electric power from the power storage device to the external facility; and
a control device that controls the power regulator.
The control device controls the power regulator so as to start to warm the power storage device when the electric power generated by the solar power generator reaches second predetermined electric power or more and then to charge the power storage device using the surplus electric power from the solar power generator.
The first predetermined electric power is determined in advance as electric power that is slightly smaller than the surplus electric power generated by the solar power generator in the external facility. In this way, the warming of the power storage device can be started shortly before the electric power generated by the solar power generator becomes surplus in the external facility. Then, when the electric power generated by the solar power generator becomes surplus in the external facility, the power storage device can be charged using the surplus electric power from the solar power generator. Therefore, the electric power loss can be reduced as compared with the case where the power storage device is constantly warmed. The external facility includes a general house.

In the in-vehicle power supply device of the second aspect of the present disclosure,

when a power storage ratio of the power storage device is equal to or more than a predetermined power storage ratio, the control device may not warm the power storage device even when the electric power generated by the solar power generator reaches the first predetermined electric power or higher.
When the power storage ratio of the power storage device is equal to or more than the predetermined power storage ratio, charging of the power storage device using the surplus electric power from the solar power generator device is not performed in some cases, and therefore electric power loss in this case can be reduced.

An in-vehicle power supply device of a second aspect of the present disclosure includes:

a power storage device;
an in-vehicle solar power generator mounted on a vehicle;
a power regulator that performs charging of the power storage device using generated electric power from the in-vehicle solar power generator, charging of the power storage device using surplus electric power from an external solar power generator installed in an external facility, and supply of electric power from the power storage device to the external facility; and
a control device that controls the power regulator, in which
the control device controls the power regulator so as to start to warm the power storage device when the electric power generated by the in-vehicle solar power generator reaches second predetermined electric power or more and then to charge the power storage device using the surplus electric power from the external solar power generator.

The in-vehicle power supply device of the second aspect of the present

disclosure includes:
an in-vehicle solar power generator mounted on a vehicle;
a power regulator that performs charging of the power storage device using generated electric power from the in-vehicle solar power generator, charging of the power storage device using surplus electric power from an external solar power generator installed in an external facility, and supply of electric power from the power storage device to the external facility; and a control device that controls the power regulator.
The control device controls the power regulator so as to start to warm the power storage device when the electric power generated by the in-vehicle solar power generator reaches second predetermined electric power or more and then to charge the power storage device using the surplus electric power from the external solar power generator.
The second predetermined electric power is determined in advance as electric power that is slightly smaller than the electric power generated by the in-vehicle solar power generator that is used as an indication that the electric power generated by the external solar power generator becomes surplus in the external facility. In this way, the warming of the power storage device can be started shortly before the electric power generated by the external solar power generator becomes surplus in the external facility. Then, when the electric power generated by the external solar power generator in the external facility becomes surplus, the power storage device can be charged using the surplus electric power from the external solar power generator. Therefore, the electric power loss can be reduced as compared with the case where the power storage device is constantly warmed. The external facility includes a general house.

In the in-vehicle power supply device of the second aspect of the present disclosure,

when a power storage ratio of the power storage device is equal to or more than a predetermined power storage ratio, the control device does not warm the power storage device even when the electric power generated by the in-vehicle solar power generator reaches the second predetermined electric power or more. When the power storage ratio of the power storage device is equal to or more than the predetermined power storage ratio, charging of the power storage device using the surplus electric power from the external solar power generator is not performed in the external facility in some cases, and therefore electric power loss in this case can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an electric power system 10 including a vehicle 20 and a house 100 on which a power supply device 30 according to the present embodiment is mounted;

FIG. 2 is a flowchart illustrating an example of a battery temperature raising process executed by the electronic control unit 40;

FIG. 3 is an explanatory diagram illustrating an exemplary temporal change between the generated electric power Ps from the solar panel 32 mounted on the vehicle, the temperature increase condition of the battery 31, the temperature Tb of the battery 31, and the charge and power supply of the battery 31 in V2H; and

FIG. 4 is a flowchart illustrating an example of a battery temperature raising process according to a modification.

### DETAILED DESCRIPTION OF EMBODIMENTS

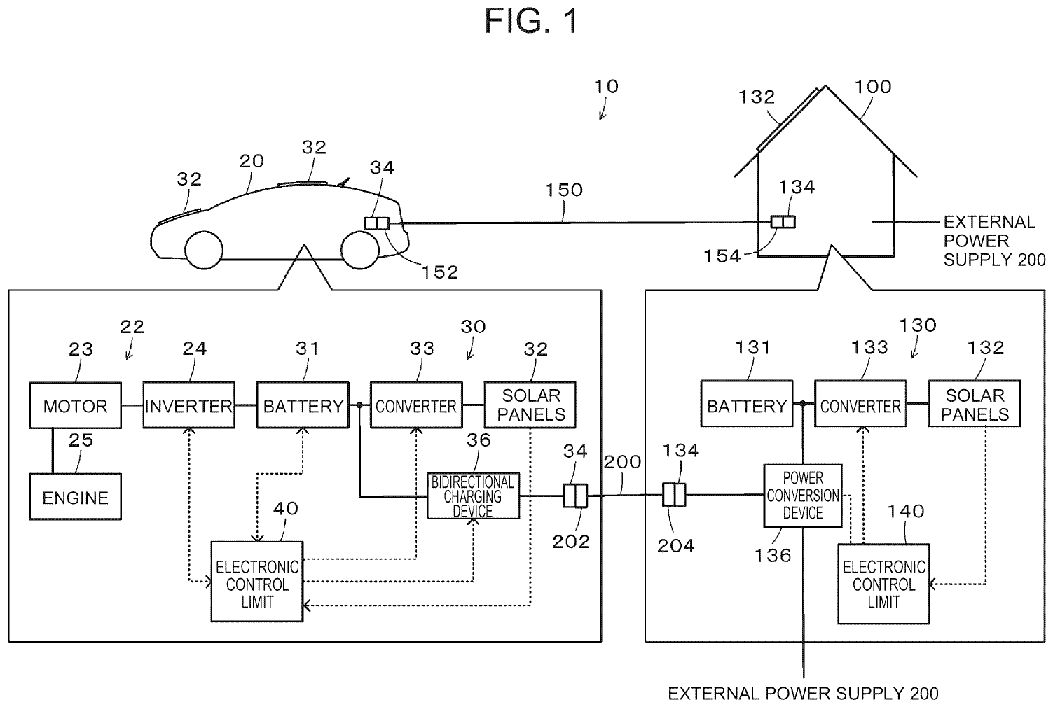

Embodiments of the present disclosure will be described with reference to the drawings. FIG. 1 is a schematic configuration diagram of an electric power system 10 including a vehicle 20 and a house 100 on which a power supply device 30 according to the present embodiment is mounted. As illustrated, the electric power system 10 includes a vehicle 20, a house 100, and an external power source 200. The vehicle 20 is configured as a hybrid electric vehicle and includes a drive unit 22 and a power supply device 30.

The drive unit 22 includes a motor 23, an inverter 24, and an engine 25. The motor 23 is configured as a synchronous generator motor, and is capable of generating electric power using the power from the engine 25 and outputting the driving power. The inverter 24 is used to drive the motor 23 and is connected to the power supply device 30 via a power line. Instead of the motor 23 and the inverter 24, a generator capable of generating electric power using the power from the engine 25, a motor capable of outputting the driving power, and two inverters for driving the generator and the motor, respectively, may be provided.

The power supply device 30 includes a battery 31 as a power storage device, a solar panel 32, a converter 33, a connector 34, a bidirectional charging device 36, and an electronic control unit 40. The battery 31 includes a plurality of secondary battery cells configured as a lithium-ion secondary battery or a nickel-hydrogen secondary battery. The solar panel 32 includes a plurality of solar cells, and is fixed to an upper surface of a roof portion of a vehicle body, an upper surface of a bonnet, or the like. The converter 33 supplies the electric power generated by the solar panel 32 to the battery 31 with voltage conversion.

The connector 34 can be connected to the power supply device 130 of the house 100 via the relay cable 150. When the connector 152 of the relay cable 150 and the connector 34 are connected and the connector 154 of the relay cable 150 and the connector 134 on the house 100 side are connected, the bidirectional charging device 36 can supply the electric power from the power supply device 130 of the house 100 to the battery 31, and can supply the electric power from the battery 31 to the power supply device 130 of the house 100.

The electronic control unit 40 includes a microcomputer, and the microcomputer includes a CPU, a ROM, RAM, a flash memory, an input/output port, and a communication port. The electronic control unit 40 receives signals from various sensors via input ports. Examples of the signals inputted to the electronic control unit 40 include a voltage Vb and a current Ib of the battery 31, a voltage Vs1 and a current Is1 on the solar panel 32 side of the converter 33, and a voltage Vs2 and a current Is2 on the battery 31 side of the converter 33. The electronic control unit 40 outputs various control signals via an output port. The signal output by the electronic control unit 40 may be, for example, a control signal to the converter 33. The electronic control unit 40 calculates the power storage ratio SOC of the battery 31 based on the integrated value of the current Ib of the battery 31. Further, the electronic control unit 40 calculates the generated electric power Ps of the solar panel 32 based on the voltage Vs1 and the current Is1 of the solar panel 32 of the converter 33. The electronic control unit 40 communicates with the electronic control unit 140 included in the power supply device 130 of the house 100 when the power supply device 30 and the power supply device 130 of the house 100 are connected by the relay cable 150. The electronic control unit 40 also functions as a control device for the drive unit 22. The electronic control unit 40 inputs a signal necessary for driving the drive unit 22 via an input port, calculates a driving torque to be output by the drive unit 22, and outputs a driving control signal to the drive unit 22 via an output port so that the calculated driving torque is output from the drive unit 22.

The power supply device 130 of the house 100 includes a battery 131, a solar panel 132, a converter 133, a power conversion device 136, and an electronic control unit 140. The battery 131 includes a plurality of secondary battery cells configured as a lithium-ion secondary battery or a nickel-hydrogen secondary battery. The solar panel 132 includes a plurality of solar cells and is fixed on the roof of the house 100. The converter 133 supplies the electric power generated by the solar panel 132 to the battery 131 with voltage conversion. When the connector 152 of the relay cable 150 and the connector 34 are connected and the connector 154 of the relay cable 150 and the connector 134 on the house 100 side are connected, the power conversion device 136 can supply the electric power from the power supply device 130 of the house 100 to the battery 31, and can supply the power from the battery 31 to the power supply device 130 of the house 100. The power conversion device 136 is connected to an external power source 200, and is capable of receiving electric power from the external power source 200 and supplying electric power to the external power source 200.

The electronic control unit 140 includes a microcomputer, and the microcomputer includes a CPU, a ROM, RAM, a flash memory, an input/output port, and a communication port. The electronic control unit 140 receives signals from various sensors via input ports. Examples of the signals inputted to the electronic control unit 140 include a voltage Vh and a current Ih of the battery 131, a voltage Vh1 and a current Ih1 of the converter 133 on the solar panel 132 side, and a voltage Vh2 and a current Ih2 of the converter 133 on the battery 131 side. The electronic control unit 140 outputs various control signals via an output port. The signals output by the electronic control unit 140 may include, for example, control signals to the converter 133. The electronic control unit 140 calculates the power storage ratio SOC of the battery 131 based on the integrated value of the current Ih of the battery 131. Further, the electronic control unit 140 calculates the generated electric power Ph of the solar panel 132 based on the voltage Vh1 and the current Ih1 of the solar panel 132 of the converter 133.

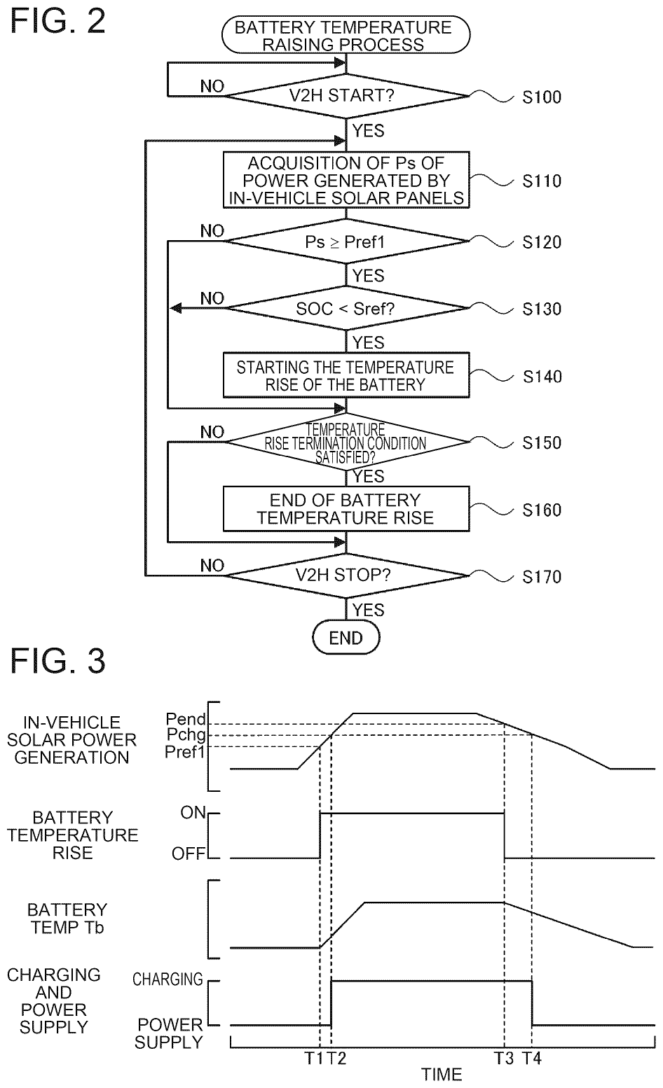

Next, the operation of the power supply device 30 of the present embodiment will be described. In particular, an operation of raising the temperature of the battery 31 at the time of charging the in-vehicle battery 31 by the surplus electric power generated from the solar panel 132 of the house 100 on the house 100 side in a state where the power supply device 30 of the vehicle 20 and the power supply device 130 of the house 100 are connected via the relay cable 150 will be described. FIG. 2 is a flowchart illustrating an example of a battery temperature raising process executed by the electronic control unit 40.

When the battery temperature raising process is executed, the electronic control unit 40 waits for Vehicle to Home (V2H) to be started (S100). The beginning of V2H is determined at the following time: That is, when the connector 152 and the connector 34 of the relay cable 150 are connected and the connector 154 of the relay cable 150 and the connector 134 of the house 100 are connected, and the electric power from the power supply device 130 of the house 100 can be supplied to the battery 31 or the electric power from the battery 31 can be supplied to the power supply device 130 of the house 100, V2H is determined to be started. Note that V2H refers to a system capable of supplying electric power from the power supply device 130 of the house 100 to the battery 31 and supplying electric power from the battery 31 to the power supply device 130 of the house 100.

When it is determined that V2H is started in S100, the generated electric power Ps from the solar panel 32 mounted on the vehicle is acquired (S110), and it is determined whether or not the acquired generated electric power Ps is equal to or higher than the threshold Pref1 (S120). The thresholds Pref1 may be determined in advance as electric power slightly smaller than the generated electric power Ps of the on-vehicle solar panel 32 in which the generated electric power Ph of the solar panel 132 is assumed to be excessive in the house 100. That is, when the generated electric power Ps of the solar panel 32 in the vehicle reaches the threshold Pref1 or more, it is predicted that surplus electric power is generated in the generated electric power Ph of the solar panel 132 in the house 100 shortly.

When it is determined in S120 that the generated electric power Ps from the solar panel 32 has reached the threshold Pref1 or more, it is determined whether or not the power storage ratio SOC of the battery 31 is less than the threshold Sref (S130). As the threshold Sref, a power storage ratio SOC that is determined to be unnecessary to charge the battery 31 can be used. When it is determined in S130 that the power storage ratio SOC of the battery 31 is less than the threshold Sref, the temperature of the battery 31 is started (S140). The temperature rise of the battery 31 is, for example, a temperature rise by the temperature raising device when a temperature raising device such as a heater is provided, and includes a temperature rise of the battery 31 by repeating charging and discharging of the battery 31 within a short time when the temperature raising device is not provided. Note that, after the temperature increase of the battery 31 is started, when surplus electric power is generated in the house 100 in the generated electric power Ph from the solar panel 132, the battery 31 is started to be charged by the surplus electric power of the generated electric power Ps from the solar panel 132.

Subsequently, it is determined whether or not the temperature rise termination condition of the battery 31 is satisfied (S150). Examples of the temperature rise termination condition of the battery 31 include a condition in which the temperature Tb of the battery 31 reaches a temperature higher than or equal to a temperature in which the temperature rise is not necessary, a condition in which the battery 31 is fully charged, a condition in which surplus electric power is not generated in the generated electric power Ps from the solar panel 32, and the like. When it is determined that the temperature rise end condition of the battery 31 is satisfied, the temperature rise of the battery 31 is ended (S160). Then, it is determined whether or not V2H is stopped (S170), and when it is determined that V2H is not stopped, the process returns to the process of acquiring the generated electric power Ps from the solar panel 32 mounted on the vehicle in S110. On the other hand, when it is determined that V2H is stopped, the present process is ended.

When it is determined in S150 that the temperature rise termination condition of the battery 31 is not satisfied, it is determined whether or not V2H is stopped without terminating the temperature rise of the battery 31 (S170). When it is determined that V2H is not stopped, the process returns to the process of acquiring the generated electric power Ps from the solar panel 32 mounted on the vehicle in S110, and when it is determined that V2H is stopped, the process ends.

When it is determined in S120 that the generated electric power Ps from the solar panel 32 is less than the threshold Pref1 or when it is determined in S130 that the power storage ratio SOC of the battery 31 is equal to or greater than the threshold Sref, the processes after S150 are performed without starting the temperature rise of the battery 31.

FIG. 3 is an explanatory diagram illustrating an exemplary temporal change between the generated electric power Ps from the solar panel 32 mounted on the vehicle, the temperature increase condition of the battery 31, the temperature Tb of the battery 31, and the charge and power supply of the battery 31 in V2H. When the generated electric power Ps from the solar panel 32 mounted in the vehicle T1 times reaches a threshold Pref1 or more, the temperature of the battery 31 starts to increase, and thereafter the temperature Tb of the battery 31 increases. At the time T2, the generated electric power Ps from the solar panel 32 mounted on the vehicle reaches a threshold Pchg or more, and surplus electric power is generated in the generated electric power Ph from the solar panel 132 in the house 100. At this time, charging of the in-vehicle battery 31 using the surplus electric power is started in the generated electric power Ph from the solar panel 132. When the temperature rise termination condition of the battery 31 is satisfied in the time T3, the temperature rise of the battery 31 is terminated. Thereafter, at the time T4, when there is no surplus electric power in the generated electric power Ph from the solar panel 132 in the house 100, charging of the in-vehicle battery 31 using the surplus electric power in the generated electric power Ph from the solar panel 132 ends.

In the power supply device 30 mounted on the vehicle 20 of the embodiment described above, when the generated electric power Ps from the solar panel 32 mounted on the vehicle reaches the threshold Pref1 or more, it is predicted that the generated electric power Ph of the solar panel 132 is surplus in the house 100 shortly, and the temperature rise of the battery 31 is started. Thereafter, in the house 100, the battery 31 is charged using the surplus electric power of the generated electric power Ph from the solar panel 32. Therefore, it is possible to reduce the electric power loss as compared with the case where the temperature of the battery 31 is constantly increased from the time when V2H is started. Moreover, when the power storage ratio SOC of the battery 31 is equal to or larger than the threshold Sref, it is determined that the battery 31 is not charged by the surplus electric power of the generated electric power Ps from the solar panel 32 in many cases. Therefore, since the temperature rise of the battery 31 is not started, the electric power loss can be further reduced.

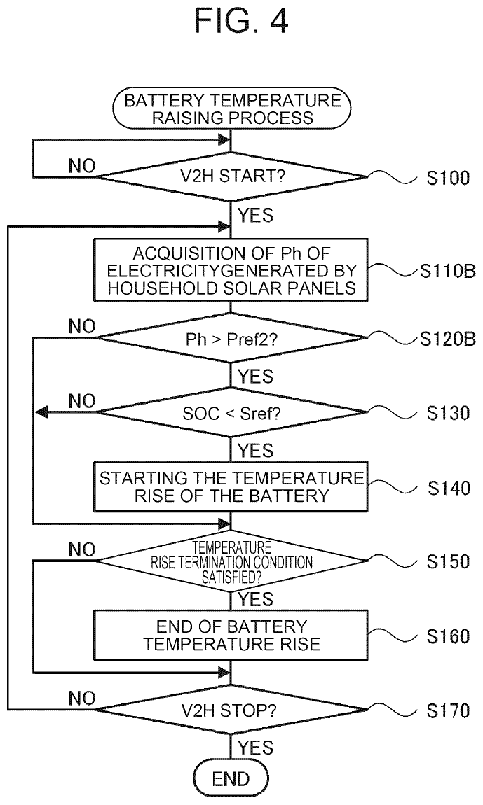

In the power supply device 30 mounted on the vehicle 20 of the embodiment, when the generated electric power Ps from the solar panel 32 mounted on the vehicle reaches the threshold Pref1 or more, it is predicted that the generated electric power Ph of the solar panel 132 will be surplus in the house 100 soon, and the temperature rise of the battery 31 is started. However, when the generated electric power Ph from the solar panel 132 of the house 100 reaches the threshold Pref2 or more, it may be predicted that the generated electric power Ph of the solar panel 132 is surplus in the house 100 soon, and the temperature rise of the battery 31 is started. An example of the battery temperature raising process in this case is shown in FIG. 4. The battery temperature raising process of FIG. 4 is the same as the battery temperature raising process of FIG. 2 except that the process of obtaining the generated electric power Ps from the in-vehicle solar panel 32 and comparing it with the threshold Pref1 in S110 and S120 of the battery temperature raising process of FIG. 2 is changed to the process of obtaining the generated electric power Ph of the solar panel 132 of the house 100 and comparing it with the threshold Pref2. In the battery temperature raising process of FIG. 4, the generated electric power Ph of the solar panel 132 of the house 100 is acquired (S110B). Then, it is determined whether or not the generated electric power Ph of the solar panel 132 of the acquired house 100 is equal to or larger than the threshold Pref2 (S120B). Then, when it is determined that the generated electric power Ph is equal to or larger than the threshold Pref2 and the power storage ratio SOC of the battery 31 is less than the threshold Sref (S130), the temperature rise of the battery 31 is started (S140). Here, the threshold Pref2 may be determined in advance as an electric power slightly smaller than a generated electric power Ph in which the generated electric power Ph of the solar panel 132 is assumed to be excessive in the house 100. That is, it is expected that surplus electric power will be generated in the generated electric power Ph of the solar panel 132 in the house 100 shortly. When the battery temperature raising process of FIG. 4 is executed, the same effects as those of the power supply device 30 of the embodiment in which the battery temperature raising process of FIG. 2 is executed can be obtained. When the battery temperature raising process of FIG. 4 is executed, the power supply device 30 may not include the solar panel 32.

In the power supply device 30 mounted on the vehicle 20 of the embodiment, even if the generated electric power Ps from the solar panel 32 mounted on the vehicle reaches the threshold Pref1 or more, the temperature rise of the battery 31 is not started when the power storage ratio SOC of the battery 31 is equal to or more than the threshold Sref. However, the temperature rise of the battery 31 may be started even when the power storage ratio SOC of the battery 31 is equal to or higher than the threshold Sref.

In the above-described embodiment, the vehicle 20 includes the drive unit 22 including the motor 23 and the engine 25, and the power supply device 30. However, the present disclosure is not limited thereto. For example, the drive unit 22 may not include the engine 25.

The correspondence between the main elements of the embodiments and the main elements of the disclosure described in the column of the means for solving the problem will be described. In the embodiment, the battery 31 is an example of a “power storage device”. The solar panel 32 is an example of an “in-vehicle solar power generator”. The house 100 is an example of an “external facility”. The solar panel 132 is an example of an “external solar power generator”. The bidirectional charging device 36 is an example of a “power regulator”. The electronic control unit 40 is an example of a “control device”. The power supply device 30 is an example of an “in-vehicle power supply device”.

The correspondence between the main elements of the embodiment and the main elements of the disclosure described in the section of the means for solving the problem is an example for specifically explaining the embodiment of the disclosure described in the section of the means for solving the problem. Therefore, the elements of the embodiments are not intended to limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a vehicle management apparatus and the like.

What is claimed is:

1. An in-vehicle power supply device comprising:
a power storage device;
an in-vehicle solar power generator mounted on a vehicle;
a power regulator that performs charging of the power storage device using generated electric power from the in-vehicle solar power generator, charging of the power storage device using surplus electric power from an external solar power generator installed in an external facility, and supply of electric power from the power storage device to the external facility; and
a control device that controls the power regulator, wherein
the control device controls the power regulator so as to start to warm the power storage device when the electric power generated by the in-vehicle solar power generator reaches first predetermined electric power or more and then to charge the power storage device using the surplus electric power from the external solar power generator.

2. The in-vehicle power supply device according to claim 1, wherein when a power storage ratio of the power storage device is equal to or more than a predetermined power storage ratio, the control device does not warm the power storage device even when the electric power generated by the in-vehicle solar power generator reaches second predetermined electric power or more.

3. An in-vehicle power supply device comprising:
a power storage device;
a power regulator that performs charging of the power storage device using surplus electric power from a solar power generator installed in an external facility, and supply of electric power from the power storage device to the external facility; and
a control device that controls the power regulator, wherein
the control device controls the power regulator so as to start to warm the power storage device when the electric power generated by the solar power generator reaches second predetermined electric power or more and then to charge the power storage device using the surplus electric power from the solar power generator.

4. The in-vehicle power supply device according to claim 3, wherein when a power storage ratio of the power storage device is equal to or more than a predetermined power storage ratio, the control device does not warm the power storage device even when the electric power generated by the solar power generator reaches first predetermined electric power or more.
